(19) United States
(12) Patent Application Publication
(10) Pub. No.: US 2023/0270310 A1
(43) Pub. Date: Aug. 31, 2023

(54) CLEANING APPARATUS AND CLEANING ROBOT SYSTEM

(71) Applicant: ECOVACS ROBOTICS CO., LTD., Suzhou (CN)

(72) Inventors: Yingyin ZHANG, Suzhou (CN); Yaya PENG, Suzhou (CN); Yong BAN, Suzhou (CN); Chao CHEN, Suzhou (CN); Zhiwei ZONG, Suzhou (CN); Xiangchao YIN, Suzhou (CN); Hua HUANG, Suzhou (CN); Qing MIAO, Suzhou (CN); He GENG, Suzhou (CN)

(73) Assignee: ECOVACS ROBOTICS CO., LTD., Suzhou (CN)

(21) Appl. No.: 18/019,700

(22) PCT Filed: Aug. 13, 2021
(86) PCT No.: PCT/CN2021/112558

§ 371 Date: Feb. 3, 2023

(30) Foreign Application Priority Data
Aug. 20, 2020 (CN) 202010845601.8

(51) Int. Cl. A47L 11/40; A47L 1/02; A47L 11/28; B08B 3/04; B08B 1/00; B08B 1/04; B08B 1/02

(52) U.S. Cl. CPC A47L 11/4091; A47L 1/02; A47L 11/28; B08B 3/04; B08B 1/005; B08B 1/04; B08B 1/02; A47L 2201/028; A47L 2201/022

(57) ABSTRACT

Provided is a cleaning apparatus, including a liquid supply tank, a liquid storage tank, a first cleaning component, a first rib, disposed on the first cleaning component, for being in contact with a member to be cleaned; where the first rib has two opposite walls protruding above a top surface of the first cleaning component, and the two opposite walls extend along a length direction of the first cleaning component; and a liquid supply port, supplying cleaning liquid in the liquid supply tank to the first cleaning component, where the liquid supply port faces down toward a liquid input end of the first cleaning component; and where liquid injected from the liquid input end flows toward the member to be cleaned and cleans the member to be cleaned under a guidance of the two opposite walls, and is collected to the liquid storage tank.

### CROSS-REFERENCE TO RELATED APPLICATIONS

The present disclosure refers to Chinese Patent Application No. 2020108456018, filed on Aug. 20, 2020, and entitled “Cleaning Apparatus and Cleaning Robot System”, which is hereby incorporated by reference in its entirety.

### TECHNICAL FIELD

The present disclosure relates to the technical field of robots, and more particularly, to a cleaning apparatus and a cleaning robot system.

### BACKGROUND

At present, some cleaning robots are provided with a mop member, such as a window wiping robot, a mopping robot, or a sweeping-mopping integrated robot. The cleaning robot removes dirt on a surface to be cleaned by using a mop member provided thereon while walking on the surface to be cleaned.

In order to reduce the inconvenience for users to change and clean the mop member frequently, more and more cleaning robots have a mop member self-cleaning function. However, the existing mop member self-cleaning function has the problems of low cleaning rate of the mop member and high water content of the cleaned mop member.

### SUMMARY

The present disclosure provides a cleaning apparatus and a cleaning robot system, which may solve or ameliorate the above-mentioned problems.

In one embodiment of the present disclosure, a cleaning apparatus is provided. The cleaning apparatus includes:
a first cleaning component; and
at least one first rib disposed on the first cleaning component for being in contact with a member to be cleaned,
where the first cleaning component has a liquid storage tank and a liquid outlet by means of the disposing of the at least one first rib;
in a working state, cleaning liquid in the liquid storage tank is maintained at a level where the cleaning liquid is in contact with the member to be cleaned, and the cleaning liquid in the liquid storage tank is updated by flowing through the liquid outlet.

In another embodiment of the present disclosure, a cleaning apparatus is provided. The cleaning apparatus includes:
a first cleaning component; and
at least one first rib disposed on the first cleaning component for being in contact with a member to be cleaned,
where the first cleaning component has a liquid storage tank by means of the disposing of the at least one first rib;
in a working state, cleaning liquid in the liquid storage tank is maintained at a level where the cleaning liquid is at least in contact with the member to be cleaned.

In yet another embodiment of the present disclosure, a cleaning robot system is also provided. The cleaning robot system includes:
a cleaning robot provided with a mop member thereon; and
a cleaning apparatus, configured to clean the mop member,
where the cleaning apparatus includes a first cleaning component and at least one rib, the at least one first rib being disposed on the first cleaning component for being in contact with the mop member;
the first cleaning component has a liquid storage tank and a liquid outlet by means of the at least one first rib, and in a working state, cleaning liquid in the liquid storage tank is maintained at a level where the cleaning liquid is in contact with the mop member, and the cleaning liquid in the liquid storage tank is updated by flowing through the liquid outlet.

In the technical solution provided by the embodiments of the present disclosure, the first cleaning component is provided with at least one first rib in contact with a member to be cleaned, and when the first cleaning component and the member to be cleaned move relative to each other (e.g. the first cleaning component moves while the member to be cleaned does not move; or the first cleaning component does not move while the member to be cleaned moves; or the first cleaning component and the member to be cleaned act at different speeds or directions). The first rib on the first cleaning component may scrape and squeeze sewage or dirt (such as hair) on the member to be cleaned, so as to clean the member to be cleaned. In addition, the cleaning liquid in the liquid storage tank on the first cleaning component is maintained at a certain level so as to be at least in contact with the member to be cleaned (such as always in contact with the member to be cleaned or sometimes in contact with and sometimes not in contact with the member to be cleaned). During the water washing of the member to be cleaned, the cleaning liquid in the liquid storage tank may be continuously discharged through the liquid outlet, and the flow of the cleaning liquid in the liquid storage tank may be updated by injecting new cleaning liquid, whereby the cleaning rate of the member to be cleaned can be improved. Furthermore, after the cleaning is completed, the cleaning liquid stops being injected, and the cleaning liquid in the liquid storage tank may be discharged through the liquid outlet, whereby the water content of the member to be cleaned can be reduced.

### BRIEF DESCRIPTION OF THE DRAWINGS

In order to describe the embodiments of the present disclosure or the technical solutions in the prior art more clearly, drawings required to be used in the embodiments or the description of the prior art will be briefly introduced below. Apparently, the drawings in the description below are some embodiments of the present disclosure. Those of ordinary skill in the art may also obtain other drawings according to the provided drawings without involving any inventive effort.

FIG. 1 is a schematic structural diagram of a cleaning apparatus provided with two first cleaning components according to an embodiment of the present disclosure;

FIG. 2 is a schematic structural diagram of a first cleaning component according to an embodiment of the present disclosure;

FIG. 3a is a schematic structural diagram of a cleaning apparatus provided with a first cleaning component and a second cleaning component according to another embodiment of the present disclosure;

FIG. 3b is a top view of the structure shown in FIG. 3a;

FIG. 4a is a schematic structural diagram of a first cleaning component provided with linear ribs according to an embodiment of the present disclosure;

FIG. 4b is a schematic structural diagram of linear ribs staggered on a first cleaning component according to an embodiment of the present disclosure;

FIG. 4c is a schematic structural diagram of a first cleaning component provided with folded and curved ribs according to an embodiment of the present disclosure;

FIG. 5 is a schematic structural diagram of a first cleaning component according to an embodiment of the present disclosure;

FIG. 6a is a schematic diagram of an elliptical first cleaning component according to an embodiment of the present disclosure;

FIG. 6b is a schematic diagram of a square first cleaning component according to an embodiment of the present disclosure;

FIG. 6c is a schematic diagram of a triangular first cleaning component according to an embodiment of the present disclosure;

FIG. 7 is a schematic structural diagram of a sewage tank in which a first cleaning component is placed according to an embodiment of the present disclosure;

FIG. 8 is a schematic structural diagram of a cleaning apparatus provided with one first cleaning component according to an embodiment of the present disclosure;

FIG. 9 is a schematic structural diagram of a mop member on a first cleaning component according to an embodiment of the present disclosure; and

FIG. 10 is a schematic diagram of a cleaning robot on a base of a cleaning apparatus according to an embodiment of the present disclosure.

### DETAILED DESCRIPTION OF EXAMPLE EMBODIMENTS

In order that those skilled in the art may better understand the solutions of the present disclosure, the technical solutions in the embodiments of the present disclosure will now be described clearly and completely with reference to the accompanying drawings in the embodiments of the present disclosure. Furthermore, the embodiments described below are only a part of the embodiments of the present disclosure, rather than all the embodiments. Based on the embodiments of the present disclosure, all other embodiments obtained by those skilled in the art without involving any inventive effort may fall within the protection scope of the present disclosure.

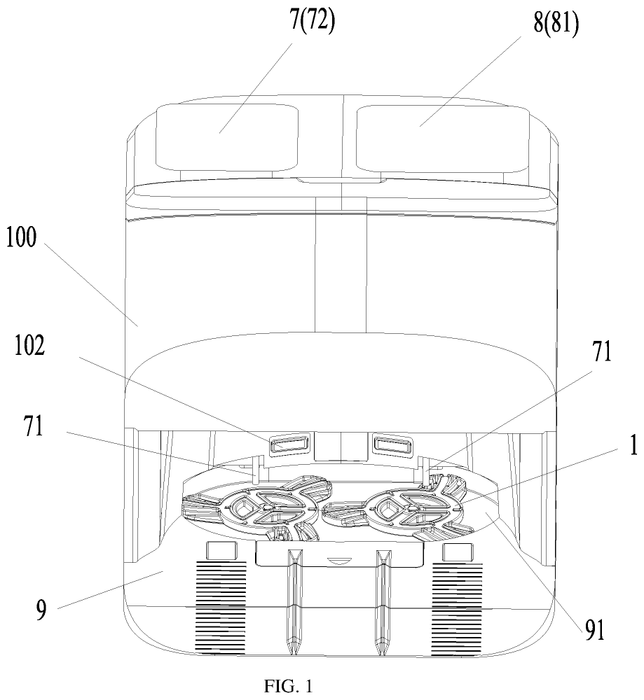

Embodiments of the present disclosure provide a cleaning apparatus. The cleaning apparatus may be of the structure shown in FIGS. 1, 2, 3a, and 3b. Specifically, referring to FIGS. 1, 2, 3a, and 3b, the cleaning apparatus 100 includes: a first cleaning component 1 and at least one first rib 21. The at least one first rib 21 is disposed on the first cleaning component 1 for being in contact with a member to be cleaned. The first cleaning component 1 has a liquid storage tank 3 by means of the at least one first rib 21. In a working state, cleaning liquid in the liquid storage tank 3 is maintained at a level where the cleaning liquid is at least in contact with the member to be cleaned.

It should be noted here that: in the working state of the cleaning apparatus 100, the cleaning liquid in the liquid storage tank 3 may always be maintained at a level where the cleaning liquid is in contact with the member to be cleaned, or may be in contact with the member to be cleaned for a period of time or not. This may be implemented by controlling a liquid supply structure of the cleaning apparatus during specific implementation. For example, in the cleaning process, the level of the cleaning liquid in the liquid storage tank 3 changes due to factors such as the water absorption of the member to be cleaned, the cleaning liquid being carried out and overflowing, and the cleaning liquid being discharged from the liquid outlet. In order to keep the level constant, a liquid supply mode (e.g. continuous liquid supply or intermittent liquid supply) and/or a liquid supply amount of the liquid supply structure may be controlled.

Further, in the cleaning apparatus of the present embodiment, by means of the disposing of the at least one first rib, the first cleaning component 1 has a liquid storage tank 3, and the first cleaning component 1 also has a liquid outlet 4. In the working state, cleaning liquid in the liquid storage tank 3 is maintained at a level where the cleaning liquid is in contact with the member to be cleaned, and the cleaning liquid in the liquid storage tank 3 is updated by flowing through the liquid outlet 4.

In this way, when the cleaning apparatus 100 is in the working state, the liquid supply structure of the cleaning apparatus may supply the cleaning liquid to the first cleaning component 1 without interruption, and the cleaning liquid in the liquid storage tank 3 flows out from the liquid outlet 4 without interruption. By controlling the liquid supply amount of the liquid supply structure, the level of the cleaning liquid in the liquid storage tank 3 may be kept constant, and the flow of the cleaning liquid in the liquid storage tank 3 can also be updated. In specific implementation, the level of the cleaning liquid in the liquid storage tank 3 may also change certainly by controlling the liquid supply amount of the liquid supply structure. For example, in the cleaning process, the level of the cleaning liquid in the liquid storage tank 3 for a period of time is a first level, and the cleaning liquid in the liquid storage tank may be in contact with the member to be cleaned at the first level. The level of the cleaning liquid in the liquid storage tank 3 for a period of time is reduced to a second level, and the cleaning liquid in the liquid storage tank cannot be in contact with the member to be cleaned at the second level. The two levels may be alternated.

In the present embodiment, the flow of the cleaning liquid in the liquid storage tank 3 is updated whereby the cleanliness of the cleaning liquid in the liquid storage tank 3 is high, which may help to improve the cleaning rate of the member to be cleaned.

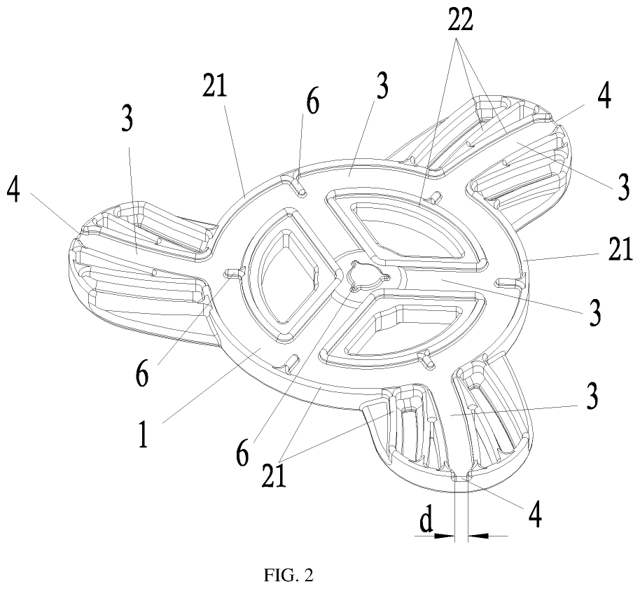

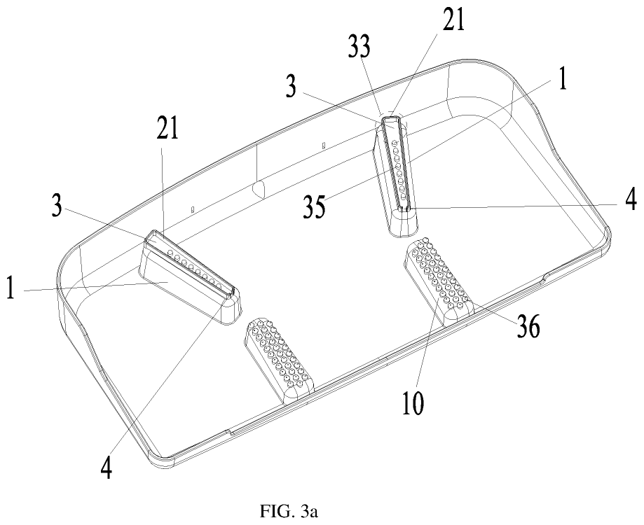

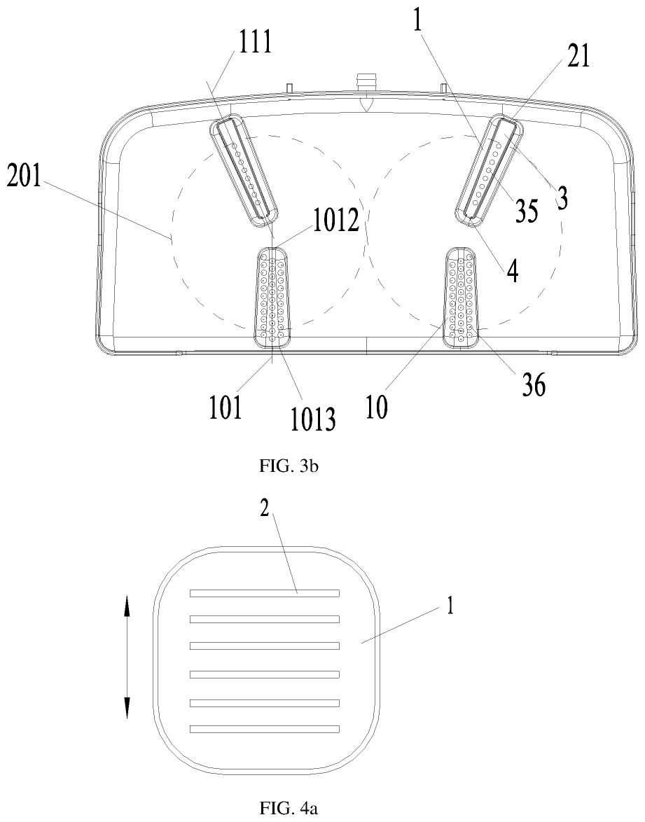

In the present embodiment, the at least one first rib 21 is disposed on the first cleaning component 1 to form a wall protruding above a surface of the first cleaning component 1. The wall formed on the surface of the first cleaning component 1 and the surface of the first cleaning component 1 surrounded by the wall which serves as a tank bottom constitute the liquid storage tank 3. Specifically, as shown in FIGS. 2 and 3a, the at least one first rib 21 is disposed on a component surface (e.g. a top surface) of the first cleaning component 1 to form a wall protruding above the surface. The wall and the surface surrounded by the wall constitute the liquid storage tank.

Referring to an embodiment shown in FIGS. 1 and 2, there are three first ribs 21, and the three first ribs 21 are disposed on the first cleaning component 1 such that the first cleaning component has the liquid storage tank 3 and the liquid outlet 4. Referring to another embodiment shown in FIGS. 3a and 3b, there is one first rib 21, and the first rib 21 is disposed on the first cleaning component 1 such that the first cleaning component has the liquid storage tank 3 and the liquid outlet 4.

In specific implementation, the first cleaning component 1 may have any shape, such as a disk shape as shown in FIGS. 1 and 2, or a cubic shape as shown in FIGS. 3a and 3b. The present embodiment is not particularly limited thereto.

The at least one first rib 21 may be disposed along a top edge of the first cleaning component 1. The liquid outlet has at least one of the following structures. Referring to FIGS. 3a and 3b, in the presence of one first rib 21, the head and tail ends of the first rib 21 are spaced apart to form the liquid outlet 4. Referring to FIG. 2, in the presence of a plurality of first ribs, the ends of the adjacent first ribs 21 are spaced apart to form the liquid outlet 4.

In the present embodiment, at least one rib is disposed on the first cleaning component for being in contact with a member to be cleaned. The first rib may scrape dirt on the member to be cleaned and may also squeeze the member to be cleaned to squeeze out sewage on the member to be cleaned when the first cleaning component and the member to be cleaned move relative to each other. The member to be cleaned absorbs the cleaning liquid in the liquid storage tank and then is squeezed by the first rib. By such repetition, the member to be cleaned can be cleaned with a high cleaning rate. Furthermore, the flow of the cleaning liquid in the liquid storage tank may be updated through the liquid outlet, whereby the cleaning liquid absorbed by the member to be cleaned has certain cleanliness, which is advantageous in further improving the cleaning rate of the member to be cleaned.

In specific implementation, the first cleaning component 1 may rotate while the member to be cleaned does not move or rotates reversely, etc. In the embodiment shown in FIGS. 1 and 2, the first cleaning component 1 rotates. Or, the first cleaning component does not move while the member to be cleaned rotates or linearly moves. In the embodiment shown in FIGS. 3a and 3b, the first cleaning component 1 does not move, etc. The present embodiment is not particularly limited thereto.

In the present embodiment, the edge of the first cleaning component has a semi-closed structure due to the presence of the liquid outlet, and when the cleaning is stopped (i.e. when the supply of the cleaning liquid is stopped), it is advantageous to timely remove water stains generated when cleaning the member to be cleaned, thereby reducing the water content of the member to be cleaned.

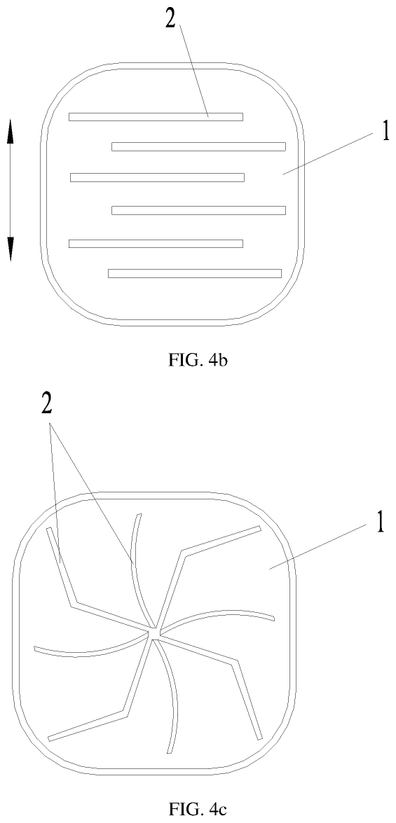

The at least one first rib may include, but is not limited to, at least one of the following: a curved rib, a linear rib, and a folded rib. The arrangement of the at least one first rib and the shape of the first rib may be selected based on the motion mode of the first cleaning component, the shape of the member to be cleaned, etc. For example, the motion mode of the first cleaning component is a linear reciprocating motion. Then the first ribs on the first cleaning component may be selected as linear ribs as shown in FIGS. 4a and 4b, and the plurality of linear ribs may be equally spaced apart perpendicular to the motion direction of the first cleaning component (as shown in FIG. 4a). The plurality of linear ribs may be arranged certainly in a staggered manner (as shown in FIG. 4b). The present embodiment is not particularly limited thereto. For another example, the motion mode of the first cleaning component shown in FIG. 4c is a rotation motion. Then the first rib on the first cleaning component may be selected as a folded rib or an arc-shaped rib shown in FIG. 4c. The first cleaning component 1 may certainly include first ribs in various shapes. For example, at least two of a curved rib, a linear rib, and a folded rib may be included at the same time. FIG. 4c shows a case where the first cleaning component 2 includes a folded rib and an arc-shaped rib.

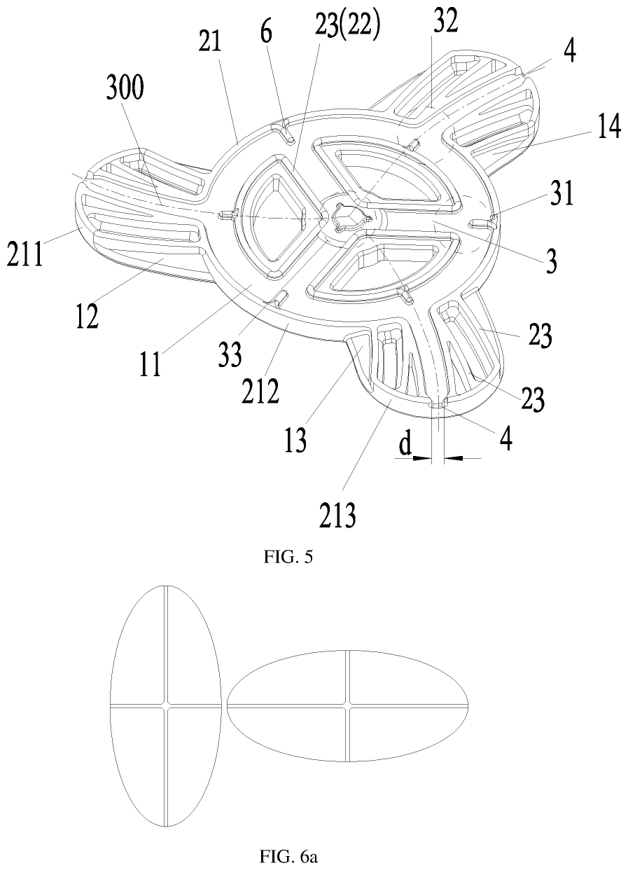

In an embodiment shown in FIGS. 2 and 5, a plurality of first ribs 21 (e.g. three first ribs 2) are disposed around the edge of the first cleaning component 1 to form an edge protruding above the top surface of the first cleaning component 1 at the edge of the first cleaning component 1. The ends of the adjacent first ribs 21 are spaced apart by a distance d to form the liquid outlet 4. Specifically, as shown in FIGS. 2 and 5, the first cleaning component 1 is shaped as a fan-shaped first cleaning component 1 including a central tray 11 and three fan trays 12, 13 and 14. The first cleaning component 1 has three edge ribs 21. For example, a first rib 21 in FIG. 5 includes a first rib section 211 on the fan tray 12, a second rib section 212 on the central tray 11, and a third rib section 213 on the other fan tray 13. In the three first ribs 21, the ends of the adjacent first ribs are spaced apart by a distance d to form the liquid outlet 4.

In order to further improve the cleaning effect, the cleaning apparatus also includes at least one second rib 22. The at least one second rib 22 is disposed on the first cleaning component 1 and located in a region surrounded by the at least one first rib 21. In specific implementation, the at least one second rib 22 may include, but is not limited to, a rib in one of the following shapes: curved ribs, annular ribs, linear ribs, folded ribs (such as v-shaped ribs), etc.

Referring to the embodiment shown in FIG. 5, the at least one second rib constitutes at least one of the following structures:
the at least one second rib defines an annular protruding structure;
the at least one second rib and the at least one first rib are combined to form an annular protruding structure.

For example, an annular protruding structure 23 located on the central tray 11 in FIG. 5 is formed by an end-to-end annular second rib 22. And, an annular protruding structure 23 located on the fan tray (e.g. the fan tray 13 in FIG. 5) is defined by a section of the first rib 21 and a linear second rib 22. Also, another annular protruding structure 23 located on the fan tray (e.g. the fan tray 13 in FIG. 5) is defined by a section of the first rib 21 and two linear second ribs (or a V-shaped second rib).

In specific implementation, the region of the first cleaning component 1 surrounded by the annular protruding structure is provided with a through hole to form a hollowed-out structure. The first cleaning component 1 is formed in a hollowed-out structure, whereby the amount of water used can be reduced, it is also convenient to dry the member to be cleaned and the first cleaning component, and liquid remaining in the annular protruding structure may leak out from the hollowed-out portion.

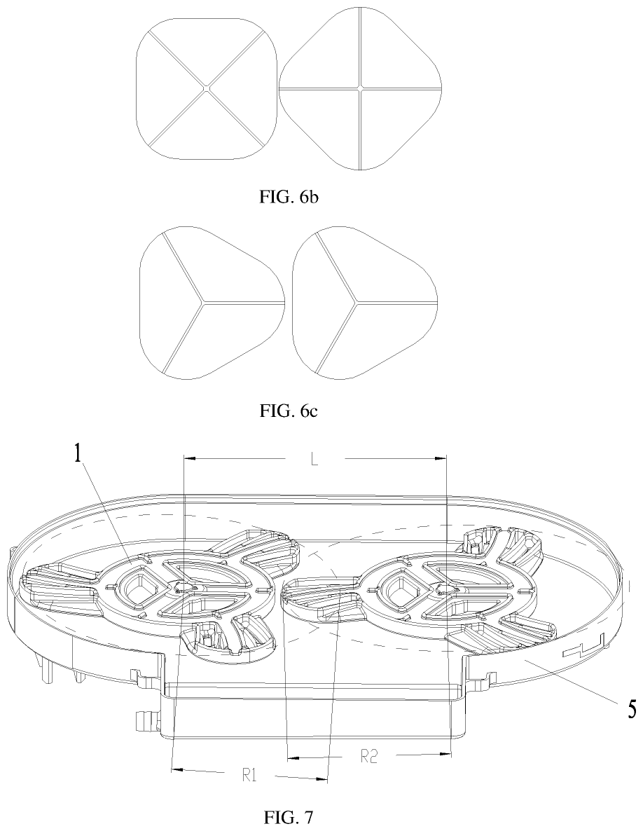

The first cleaning component 1 in the present embodiment may include, but is not limited to, at least one of the following shapes: elliptical (as shown in FIG. 6a), square (as shown in FIG. 6b), triangular (as shown in FIG. 6c), pentagonal, hexagonal, fan-shaped (as shown in FIGS. 2 and 5), circular, etc. There may be two first cleaning components 1, as shown in FIG. 1. If the motion mode of the first cleaning components 1 is a rotation mode, the two first cleaning components 1 may be disposed in a staggered rotation manner. That is, in a realizable technical solution, the cleaning apparatus has two first cleaning components 1, which are disposed in a staggered rotation manner. The staggered rotation manner may be simply understood as an arrangement manner in which the distance between the centers of rotation of the two first cleaning components is less than the sum of the maximum radii of rotation of the two first cleaning components. The two first cleaning components synchronously rotate without interference.

Specifically, the first cleaning components 1 each include a central tray and a fan tray. The fan tray is disposed at an edge of the central tray. The distance between the centers of the central trays of the two first cleaning components 1 is less than the sum of the maximum radii of rotation of the two first cleaning components. The maximum radium of rotation of the first cleaning components is the distance from the fan tray to the distal end of the central tray and the center of the central tray. Referring to FIG. 7, there are three fan trays (as shown by reference numerals 12, 13 and 14), uniformly distributed along the circumference of the central tray. The center distance between the left first cleaning component 1 and the right first cleaning component 1 is L. The staggered rotation manner of the two first cleaning components satisfies: L<R1+R2, where R1 is the maximum radium of rotation of the left first cleaning component 1, and R2 is the maximum radium of rotation of the right first cleaning component 1.

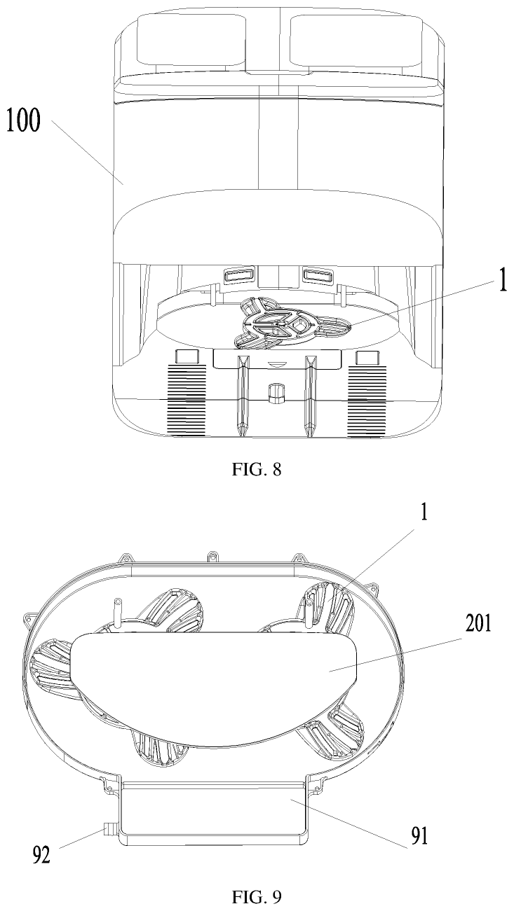

There may also be one, three, four, or more first cleaning components 1 (as shown in FIG. 8) certainly. The present embodiment is not particularly limited thereto.

Further referring to the embodiment shown in FIGS. 2 and 5, the first cleaning component 1 includes a central tray 11. The central tray 11 has a central region. The plurality of annular protruding structures 23 are located around the central region to form the liquid storage tank 3 radiating from the central region in a plurality of directions toward an edge and extending along the edge to the liquid outlet. For example, the shape and size of the three annular protruding structures 23 are all the same in the figure. The central tray 11 is a circular tray, the three annular protruding structures are spaced apart by 120 degrees and arranged around the central region to obtain three liquid storage tanks 3 scattering from the central region toward an edge of the central tray as shown in FIGS. 2 and 5.

Further, as shown in FIG. 5, the first cleaning component 1 may also include fan trays 12, 13 and 14. FIG. 5 shows a case where three fan trays are included. In practice, there may also be one, two or four fan trays. The present embodiment is not particularly limited thereto. The fan tray is disposed at the outer periphery of the central tray. The fan trays 12, 13 and 14 in FIG. 5 are spaced apart by 120 degrees in the radial direction of the central tray. The liquid outlet 4 may be located on the fan tray. Each of the fan trays 12, 13 and 14 may have a liquid outlet. The liquid storage tank on the first cleaning component 1 extends from the central tray 11 to the fan tray. The fan tray has a tank section of the liquid storage tank 3. Both sides of the tank section on the fan tray (e.g. the fan tray 13 in FIG. 5) are provided with the at least one annular protruding structure 23 respectively.

When the first cleaning component is operated in a rotation motion manner, the first cleaning component may generate a centrifugal force during the rotation, and the liquid in the liquid storage tank may be thrown out of the liquid outlet by the centrifugal force. In order to facilitate the outflow of the liquid in the liquid storage tank, the tank section on the fan tray may be designed in an arc shape. As shown in FIG. 5, a tank centerline 300 of the tank section is an arc line, and more specifically may be a plane spiral line.

Referring to FIG. 5, the first ribs 21 on both sides of the tank section on the fan tray are retracted inwardly to expose part of a tray surface outside the first ribs 21. In general, the first cleaning component 1 will be placed in a sewage tray 5 as shown in FIG. 7. Sewage is stored in the sewage tray 5. If the edges of the fan trays of the first cleaning component 1 are all surrounded by the first rib 213, when the first cleaning component 1 rotates, the fan trays directly impact the sewage in a plane to generate a great splash, and the sewage may easily enter the water storage tank of the first cleaning component. The first ribs on the fan trays are retracted inwardly to expose part of the tray surface which can achieve the effect of weakening the splash.

With continued reference to FIGS. 2 and 5, in the cleaning apparatus provided by the present embodiment, a drainage rib 6 may also be disposed in the liquid storage tank 3 on the first cleaning component 1. The drainage rib 6 in the liquid storage tank 3 is configured to diverge the fluid in the liquid storage tank 3 to be discharged from the plurality of liquid outlets 4.

More specifically, referring to FIGS. 2 and 5, at least one junction 31 is provided in a fluid channel formed by the liquid storage tank 3. The drainage rib 6 is disposed at the junction 31. As shown in FIG. 5, the junction 31 is formed by edge ribs and two annular protruding structures. The drainage rib 6 at the junction 31 may be disposed at the edge rib, and extends toward the tank section between the two annular protruding structures. At the junction 32 in FIG. 5, the drainage rib 31 is disposed on an internal rib forming the annular protruding structure, and extends toward the tank section on the fan tray. For another example, the junction 33 in FIG. 5 is formed by three annular protruding structures surrounding the central region. A central island may be disposed at 33, and the central island is provided with three drainage ribs 6 respectively extending toward each tank section.

The drainage ribs shown in FIGS. 2 and 5 are linear ribs. In practice, drainage ribs of other shapes such as curved ribs and folded ribs may be selected according to specific situations. The present embodiment is not particularly limited thereto. The shape selection and position setting of the drainage ribs should be determined according to the structure of the first cleaning component, the structure of the liquid storage tank, the motion mode of the first cleaning component, the fluid design, etc.

In the embodiment shown in FIGS. 1, 2 and 5, the first cleaning component 1 may rotate. That is, the cleaning apparatus provided by the present embodiment may also include a rotation driving mechanism (not shown in the figures) for driving the rotation of the first cleaning component. In specific implementation, the rotation driving mechanism may include: a motor and a transmission mechanism (e.g. a speed reduction mechanism).

In another realizable embodiment as shown in FIGS. 3a and 3b, there is one liquid outlet. The liquid storage tank 3 has a liquid input end 33, and the liquid input end 33 and the liquid outlet 4 are located at two opposite ends of the liquid storage tank 3. More specifically, as shown in FIGS. 3a and 3b, a tank width of the liquid storage tank 3 is reduced from the liquid input end 33 to the liquid outlet 4. The narrow design of the liquid outlet end of the liquid storage tank is for liquid storage. If the width of the liquid outlet is too large, the outflow volume of the cleaning liquid in the liquid storage tank is too large. In order to ensure the level in the liquid storage tank, the liquid supply amount needs to be increased, and the water consumption is inevitably increased.

In the embodiment shown in FIGS. 3a and 3b, the first cleaning component 1 does not move while the member to be cleaned acts (e.g. rotates). The top structure of the first rib 21 is adapted to the member to be cleaned in order that the first rib 21 is in contact with the member to be cleaned. For example, the member to be cleaned has a certain slope. Then the top structure of the first rib 21 should also conform to the slope of the member to be cleaned in order that the top thereof is in contact with the member to be cleaned.

Further, the first cleaning component 1 does not move, and the tank bottom of the liquid storage tank may be designed to be inclined in order that the cleaning liquid in the liquid storage tank 3 is discharged from the liquid outlet 4. Specifically, as shown in FIG. 3a, the tank bottom height of the liquid storage tank 3 is reduced from the liquid input end 33 to the liquid outlet 4. The liquid outlet 4 is lower than the liquid input end 33, and liquid injected into the liquid storage tank 3 flows toward the liquid outlet 4 under the action of gravity.

Referring to FIGS. 3a and 3b, a plurality of first projections 35 may be disposed in the water storage tank 3. The plurality of first projections 35 are configured to be in contact with a member to be cleaned (e.g. a mop member) to scrape the member to be cleaned, so as to clean the member to be cleaned. In addition, the at least one first projection 35 in the water storage tank 3 also achieves the purpose of filling the water storage tank and reducing the amount of liquid used. The one or more first projections 35 may be hemispherical bumps, cylindrical projections, conical projections and the like. The present embodiment is not particularly limited thereto. The first projection 35 may be disposed at the bottom of the water storage tank 3.

Furthermore, as shown in FIGS. 3a and 3b, there may be one, two or more first cleaning components in the present embodiment, depending on the structure space of the cleaning apparatus, the number and shape of the members to be cleaned, etc. In addition to the first cleaning component, the cleaning apparatus may also include a second cleaning component 10. The second cleaning component 10 may be provided with a plurality of second protrusions 36 thereon. The plurality of second protrusions 36 are configured to be in contact with the member to be cleaned. The second projections 36 may be hemispherical bumps, cylindrical projections, conical projections and the like. The present embodiment is not particularly limited thereto.

The shape and structure of the first cleaning component 1 and the second cleaning component 10 may be the same or similar. As shown in the examples of FIGS. 3a and 3b, the first cleaning component 1 and the second cleaning component 10 are each of a cube structure. A first rib 21 is disposed at the top of the first cleaning component 1. The plurality of second protrusions 36 are uniformly distributed on the second cleaning component 10. The second cleaning component 10 includes a proximal end 1012 proximal to the first cleaning component 1 and a distal end 1013 distal to the first cleaning component 1. The width of the second cleaning component 10 is reduced from the distal end 1013 to the proximal end 1012.

In specific implementation, the first cleaning component 1 and the second cleaning component 10 may be disposed in the manner shown in FIG. 3b, i.e. an axis 111 of the first cleaning component 1 and an axis 101 of the second cleaning component 10 have an included angle (e.g. an obtuse angle). If the member to be cleaned is circular (e.g. the member to be cleaned 201 in FIG. 3b), the intersection of the axes 111 and 101 may be located at the center of the member to be cleaned. Or, the first cleaning component 1 and the second cleaning component 10 are disposed on the same straight line. In specific implementation, a positional relationship between the first cleaning component 1 and the second cleaning component 10 may be determined according to actual space conditions.

Referring to FIGS. 1 and 9, the cleaning apparatus provided by the present embodiment may also include: a liquid supply structure, a liquid storage structure, a base, etc. The liquid supply structure 7 has a liquid supply port 71 for supplying the cleaning liquid to the first cleaning component 1. The liquid supply port faces down toward the liquid storage tank. The cleaning liquid may be water, an aqueous solution containing washing liquid, etc. Specifically, the liquid supply structure may include: a liquid supply tank 72, a water pump (not shown in the figures), etc. The water or aqueous solution in the liquid supply tank 72 is pumped out by the water pump and flows to the first cleaning component 1 through the liquid supply port 71. The water pump may not be provided certainly, and the liquid in the liquid supply tank 72 may flow out from the liquid supply port 71 by its own weight. A liquid supply switch may be disposed at the liquid supply port 71, and the liquid supply port may be opened or closed by controlling the liquid supply switch. The liquid storage structure may include: a liquid storage tank 81, a water pump (not shown in the figures), etc. The liquid storage tank 81 may be configured to store liquid (essentially sewage) discharged from the liquid outlet. The base 9 is provided with at least one first cleaning component 1. More specifically, a sewage tank 91 may be disposed in the base 9. Referring to FIG. 9, the sewage tank 91 is provided with a water outlet 92, and a water outlet pipe and a water pump may be connected to the water outlet 92, so as to pump sewage into the liquid storage tank 81.

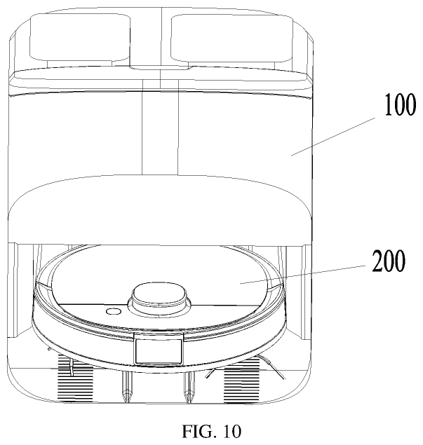

FIG. 10 shows a case where a robot 200 (e.g. a mopping robot or a sweeping-mopping integrated robot) travels onto the base 9 of the cleaning apparatus. After the robot 200 travels onto the base 9, a member to be cleaned 201, such as a mop member (or rag), at the bottom of the robot 200 is located above the first cleaning component 1, as shown in FIG. 9. The first cleaning component 1 rotates, the first rib, the second rib, the first protrusion, the second protrusion, etc. on the first cleaning component 1, and the aqueous solution supplied to the first cleaning component by the liquid supply structure, are all in contact with the member to be cleaned 201, and at least one of the first rib, the second rib, the first protrusion, and the second protrusion scrapes dirt on the mop member and squeezes water. The mop member absorbs the aqueous solution on the first cleaning component, and at least one of the first rib, the second rib, the first protrusion, and the second protrusion squeeze again. The cleaning can be performed effectively by repetitions.

The sewage tank 91 in which the first cleaning component is placed facilitates, on the one hand, collection of sewage generated when cleaning and squeezing the member to be cleaned. On the other hand, by injecting water to the first cleaning component, the first cleaning component rotates so that components including the first cleaning component, the sewage tank, and the like can be cleaned, thereby reducing dirt residue in the cleaning apparatus, and achieving a self-cleaning effect.

Further, the cleaning apparatus of the present embodiment may charge the robot in addition to cleaning the member to be cleaned of the robot. As shown in FIG. 1, the cleaning apparatus is also provided with a charging mechanism 102. The charging mechanism 102 is configured to be electrically connected to the robot after the robot is placed on the base, so as to supply a charging voltage. Specifically, the charging mechanism may include, for example, a charging interface, a charging circuit, etc. The charging interface is adapted to an interface on the robot, and after the robot travels onto the base, the interface on the robot may complete docking with the charging interface on the cleaning apparatus to charge the robot.

As shown in FIGS. 1, 8 and 10, the liquid supply tank 72 in the liquid supply structure 7 and the liquid storage tank 81 of the liquid storage structure 8 may be disposed above the base 9, e.g. the liquid supply tank 72 is disposed alongside the liquid storage tank 81. A space for accommodating the robot is provided between the base 9 and the bottoms of the liquid supply tank 72 and the liquid storage tank 81. The charging interface of the charging mechanism 102 may be disposed on a space wall of this space.

The technical solution provided by the present embodiment has the following beneficial effects:

The cleaning apparatus may automatically clean members to be cleaned with a good cleaning effect.

The cleaning apparatus may collect and store sewage generated during cleaning.

Since the liquid storage tank and the liquid outlet are designed in the cleaning apparatus, the cleaning liquid in the liquid storage tank is always maintained at a certain level so as to be in contact with the member to be cleaned. During the water washing of the member to be cleaned, the cleaning liquid in the liquid storage tank may be continuously discharged through the liquid outlet, and the flow of the cleaning liquid in the liquid storage tank can be updated by injecting new cleaning liquid, whereby the cleaning rate of the member to be cleaned can be improved. In addition, after the cleaning is completed, the cleaning liquid stops being injected, and the cleaning liquid in the liquid storage tank may be discharged through the liquid outlet, whereby the water content of the member to be cleaned can be reduced.

Since the first cleaning component of the cleaning apparatus shown in FIG. 5 is designed in a hollowed-out structure, the amount of water used during cleaning can be reduced. A plurality of first projections are disposed in the water storage tank in another cleaning apparatus as shown in FIG. 3a can reduce the amount of water used in addition to the effect of cleaning the member to be cleaned (which is the main effect of the first projections).

With the solution in which the first cleaning component rotates as shown in FIG. 5, it is also possible to clean the sewage tray, thereby achieving the self-cleaning effect of the cleaning apparatus.

Referring to FIG. 10, yet another embodiment of the present disclosure provides a cleaning robot system. The system includes: a cleaning robot 200 and a cleaning apparatus 100. The cleaning robot 200 is provided with a mop member 201 thereon, such as rag. As shown in FIGS. 1, 2, 3a, and 3b, the cleaning apparatus 100 includes a first cleaning component 1 and at least one first rib 21. The at least one first rib 21 is disposed on the first cleaning component 1 for being in contact with the mop member. By means of the at least one first rib 21, the first cleaning component 1 has a liquid storage tank 3 and a liquid outlet 4. In a working state, cleaning liquid in the liquid storage tank 3 is maintained at a level where the cleaning liquid is in contact with the mop member, and the cleaning liquid in the liquid storage tank 3 is updated by flowing through the liquid outlet 4.

In the present embodiment, the cleaning robot may be separated from the cleaning apparatus to perform a cleaning task after the cleaning of the mop member is completed. The cleaning apparatus may be configured to charge the cleaning robot in addition to cleaning the mop member of the robot. The cleaning robot is configured to clean planes (such as floors or glass surfaces). When the cleaning robot needs to be charged and/or needs to clean the mop member after the mop member has been mopping for some time, the cleaning robot can automatically travel to the cleaning apparatus where the charging and/or cleaning of the mop member is performed.

There may be one or more mop members 201 disposed at the bottom of the cleaning robot 200. The mop member may be a mop member cloth (or referred to as rag) or sponge or any other type of component capable of mopping floors.

The shape and size of the first cleaning component and the structure of the first rib on the first cleaning component are related to the shape, size and motion mode of the mop member. As the area of the rib on the first cleaning component acting on the mop member during cleaning is larger, the cleaning efficiency is higher certainly.

Further, in the cleaning robot system of the present embodiment, as shown in FIG. 5, the cleaning apparatus may also include at least one second rib 22. The at least one second rib 22 is disposed on the first cleaning component 1 and located in a region surrounded by the at least one first rib.

Furthermore, as shown in FIG. 5, the at least one second rib 21 constitutes at least one of the following structures: the at least one second rib 22 defines an annular protruding structure 23; the at least one second rib 22 and the at least one first rib 21 are combined to form an annular protruding structure. In a specific implementation solution, the region of the first cleaning component 1 surrounded by the annular protruding structure 23 is provided with a through hole to form a hollowed-out structure.

It should be noted here that: the cleaning apparatus in the cleaning robot system of the present embodiment may be the cleaning apparatus described above. With regard to the specific implementation structure of the cleaning apparatus, reference may be made to the corresponding contents above, and the description thereof will not be repeated here.

The technical solution provided by the present embodiment is described below in conjunction with specific application scenarios.

Application Scenario 1

A mopping robot mops at home. When a detection device of the mopping robot detects that a mop member needs to be cleaned or after the mopping reaches a certain period of time, the mopping robot stops the mopping and travels to a toilet. After reaching the toilet, the mopping robot moves to a base of a cleaning apparatus by means of a guiding program. At this moment, the cleaning apparatus controls a liquid supply mechanism to supply clean water to a first cleaning component while also controlling the first cleaning component to rotate after detecting that the mopping robot is located on the base. Both a first rib and a second rib on the first cleaning component are in contact with the mop member. During rotation, the mop member is squeezed while scraping dirt (such as hair) on the mop member to squeeze out sewage. The squeezed sewage flows into a sewage tank from a liquid outlet of a liquid storage tank on the first cleaning component and a hollowed-out structure. During rotation of the first cleaning component, the sewage in the sewage tank is stirred to entrain a portion of sediment together into the liquid storage tank through a water outlet of the sewage tank and a water pump. The cleaning apparatus cleans the mop member and also simultaneously cleans the sewage tank. For example, after the expiration of cleaning time (e.g. 10 minutes), the mopping robot descends from the base and travels to a target location to continue the mopping task.

Application Scenario 2

A mopping robot mops at home. When the remaining power of the mopping robot is low, the mopping robot travels to a toilet. After reaching the toilet, the mopping robot moves to a base of a cleaning apparatus by means of a guiding program, and docks with a charging interface on the cleaning apparatus, so as to be charged. At the time of charging, the cleaning apparatus controls a liquid supply mechanism to supply clean water to a first cleaning component while also controlling the first cleaning component to rotate. A first rib on the first cleaning component is in contact with the mop member. During rotation, the mop member is squeezed while scraping dirt (such as hair) on the mop member to squeeze out sewage. The squeezed sewage flows into a sewage tank from a liquid outlet of a liquid storage tank on the first cleaning component and a hollowed-out structure. During rotation of the first cleaning component, the sewage in the sewage tank is stirred to entrain a portion of sediment together into the liquid storage tank through a water outlet of the sewage tank and a water pump. The cleaning apparatus cleans the mop member and also simultaneously cleans the sewage tank. For example, after the expiration of cleaning time (e.g. 10 minutes), the cleaning apparatus stops cleaning the mop member. After being charged completely, the mopping robot descends from the base and travels to a target location to continue the mopping task.

Application Scenario 3

When a detection device of a mopping robot detects that a mop member needs to be cleaned, the mopping robot stops the mopping and travels to a base of a cleaning apparatus. After moving the base, the mopping robot drives the mop member to rotate. The cleaning apparatus controls a liquid supply mechanism to supply clean water to a first cleaning component. A first rib and a first protrusion on the first cleaning component and second protrusions on a second cleaning component are all in contact with the mop member. During the rotation of the mop member, the mop member is squeezed while scraping dirt (such as hair) on the mop member to squeeze out sewage. The squeezed sewage flows into a sewage tank from a liquid outlet of a liquid storage tank on the first cleaning component, and flows into the sewage tank between the second protrusions of the second cleaning component. The sewage in the sewage tank enters the liquid storage tank through a water outlet of the sewage tank and a water pump. For example, after the expiration of cleaning time (e.g. 10 minutes), the mopping robot descends from the base and travels to a target location to continue the mopping task.

Finally, it should be noted that, the above embodiments are provided only to illustrate the technical solutions of the present disclosure but not to be limiting thereof. Although the present disclosure has been described in detail with reference to the foregoing embodiments, those of ordinary skill in the art will appreciate that the technical solutions disclosed in the foregoing embodiments may still be modified, or some of the technical features thereof may be substituted equivalently. Such modifications or substitutions do not depart the corresponding technical solutions from the spirit and scope of the technical solutions in the various embodiments of the present disclosure in nature.

1.-24. (canceled)

25. A cleaning apparatus, comprising:
a liquid supply tank;
a liquid storage tank;
a first cleaning component;
a first rib, disposed on the first cleaning component, for being in contact with a member to be cleaned;
wherein the first rib has two opposite walls protruding above a top surface of the first cleaning component, and the two opposite walls extend along a length direction of the first cleaning component;
a liquid supply port, supplying cleaning liquid in the liquid supply tank to the first cleaning component, wherein the liquid supply port faces down toward a liquid input end of the first cleaning component;
and wherein liquid injected from the liquid input end flows toward the member to be cleaned and cleans the member to be cleaned under a guidance of the two opposite walls, and is collected to the liquid storage tank.

26. The cleaning apparatus according to claim 25, wherein an area on the first cleaning component being in contact with the member to be cleaned does not cover the liquid input end, so that the cleaning liquid first contacts the first cleaning component and then contacts the member to be cleaned.

27. The cleaning apparatus according to claim 26, wherein at least part of the first rib is not in contact with the member to be cleaned.

28. The cleaning apparatus according to claim 25, wherein the liquid input end is located in an area surrounded by the first rib.

29. The cleaning apparatus according to claim 25, wherein a height of a surface of the first cleaning component between the two opposite walls is reduced along a direction from an edge of the member to be cleaned to a center of the member to be cleaned.

30. The cleaning apparatus according to claim 29, wherein the height of the first cleaning component changes continuously.

31. The cleaning apparatus according to claim 25, wherein a distance between the two opposite walls is reduced along a direction from the edge of the member to be cleaned to the center of the member to be cleaned.

32. The cleaning apparatus according to claim 31, wherein the distance between the two opposite walls changes continuously.

33. The cleaning apparatus according to claim 25, wherein there are at least two the first cleaning components being disposed with the first rib; the at least two first cleaning components extend along directions of at least two radius of a circle; and a center of the circle corresponds to the center of the member to be cleaned.

34. The cleaning apparatus according to claim 25, wherein at least two first projections are disposed between the two opposite walls, and the at least two first projections are used for being in contact with the member to be cleaned; and at least two first projections are spaced along an extension direction of the two opposite walls.

35. The cleaning apparatus according to claim 25, wherein an area on the first cleaning component being in contact with the member to be cleaned comprises an area a first projection being disposed.

36. The cleaning apparatus according to claim 25, further comprising:
a second cleaning component, disposed with at least two second projections for being in contact with the member to be cleaned;
wherein the second cleaning component extends along a direction from an edge of the member to be cleaned to a center of the member to be cleaned; and
the first cleaning component and the second cleaning component extend along two directions of two radius of one same circle respectively.

37. The cleaning apparatus according to claim 36, wherein the first cleaning component has a first axis along an extension direction of the first cleaning component;
the second cleaning component has a second axis along an extension direction of the second cleaning component; and
the first axis and the second axis are intersected, and an intersection point is a center of the member to be cleaned.

38. The cleaning apparatus according to claim 36, wherein the first cleaning component has a proximal end proximal to the second cleaning component, and the liquid outlet is located at the proximal end of the first cleaning component.

39. The cleaning apparatus according to claim 36, wherein a gap is provided between ends of the first cleaning component and the second cleaning component closing to a center of the circle.
